(19) United States
(12) Patent Application Publication
(10) Pub. No.: US 2011/0055229 A1
(43) Pub. Date: Mar. 3, 2011

(54) SYSTEM AND METHOD FOR GENERATING A VALUATION OF REVENUE OPPORTUNITY FOR A KEYWORD FROM A VALUATION OF ONLINE SESSIONS ON A WEBSITE FROM USER ACTIVITIES FOLLOWING A KEYWORD SEARCH

(75) Inventor: Anurag Kumar, Bangalore (IN)

(73) Assignee: Yahoo! Inc., Sunnyvale, CA (US)

(21) Appl. No.: 12/547,468

(22) Filed: Aug. 25, 2009

(51) Int. Cl. G06F 17/30

(52) U.S. Cl. 707/751; 707/E17.071

(57) ABSTRACT

An improved system and method for generating a valuation of online sessions on a website following a keyword search. The revenue generated for online sessions of users for pairs of keyword/referrer may be calculated from activities performed on the website during the online sessions and may be added to a sum representing the session value for the pair of keyword/referrer on the website. In an embodiment, the revenue opportunity of the pairs of keyword/referrer for a website may be estimated by multiplying the session value by the difference of a total count of clicks for multiple websites on search results by a referrer for the keyword and a count of clicks for the website on search results by a referrer for the keyword. The pairs of keyword/referrer may be ranked for the website by the estimated revenue opportunity, and then applied to optimize monetization of online content.

### FIELD OF THE INVENTION

The invention relates generally to computer systems, and more particularly to an improved system and method for generating a valuation of revenue opportunity for a keyword from a valuation of online sessions on a website from user activities following a keyword search.

### BACKGROUND OF THE INVENTION

Monetization of websites continues to develop in order to support the growth of new and existing services provided on the Internet. Online services initially introduced subscription fees to generate revenue to support online services. Monetization models have since evolved to replace subscription fees with advertising revenue for many basic services now offered for free. Currently, combinations of monetization models exist on many online services and websites.

Unfortunately, current valuation methods of online users or websites capture limited information of monetization. Metrics for each monetization model were generally developed for charging and collecting revenues for each individual monetization model. For instance, click through rate and advertisement views provide metrics of online advertising revenue. Also, subscriber counts may provide a metric for paid subscription services. However, click through rate does not take into account the value of the click, whether the click generated $1 or $20. Similarly, metrics for advertisement views do not take into consideration the value of cost per million (CPM) impressions generated by an advertisement server. Furthermore, none of the existing metrics takes into consideration shopping clicks, subscription fees, actual revenues and costs consolidation from accounting systems. Moreover, limited information is captured of online user activities that drive user traffic to a website, and, without better information, it is difficult to improve the identification, quantification and monetization of such activities.

What is needed is a way for a system and method to better capture the valuation of user activities that may contribute to revenue through various monetization models and to better monetize such activities.

### SUMMARY OF THE INVENTION

Briefly, the present invention may provide a system and method for generating a valuation of revenue opportunity for a keyword from a valuation of online sessions from user activities on a website following a keyword search. To generate a valuation of revenue opportunity for a keyword from a valuation of online sessions on a website following a keyword search, the revenue generated for online sessions of users for pairs of keyword/referrer may be calculated for a website. In general, the revenue generated for online sessions of users may be derived from activities performed by each of the users on the website during the online sessions. In an embodiment, pairs of keyword/referrer may be received for online sessions of users on the website, and the revenue may be calculated for the activities on the website for individual user sessions. The revenue calculated for the activities on the website for individual user sessions may be added to a sum representing the session value for the pair of keyword/referrer on the website. And the session value for the pair of keyword/referrer on the website may be output, such as storing the value by website identifier in a database. In another embodiment, the session value for the pair of keyword/referrer on the website may be calculated as the difference of the sum of revenue calculated for individual user sessions for the pair of keyword/referrer on the website and the sum of costs calculated for individual user sessions for the pair of keyword/referrer on the website. To calculate the revenue and cost for activities of a user on a website, in an embodiment, values for each type of activities of a user on website may be accumulated and input into a function with the value of a revenue type or cost type associated with activities of users on the website.

After the revenue generated for online sessions of users for pairs of keyword/referrer may be calculated for a website, the revenue opportunity of the pairs of keyword/referrer may be estimated for the website using the session value calculated for online sessions of users for pairs of keyword/referrer. The pairs of keyword/referrer may be ranked for the website by the estimated revenue opportunity, and the list of pairs of keyword/referrer ranked by the estimated revenue opportunity may be stored for the website. The list of pairs of keyword/referrer ranked by the estimated revenue opportunity for the website may then be applied to optimize monetization of online content. For example, content on the website may be identified for keywords in the ranked list with the greatest estimate revenue opportunity and tagged with the keywords for identification by web crawlers for search engines. As another example, online keyword auction applications may also increase bid value for keywords in the ranked list with greatest estimate revenue opportunity.

Advantageously, the present invention may support many applications for optimizing monetization of content by generating a valuation of a keyword on a website from users' online sessions following a keyword search. For example, an application may calculate the average revenue generated by users' online session for a keyword from a referrer, and the application may then estimate the revenue share attributed to the keyword for the website from an estimated total click count for websites from search results generated for the keyword by the referrer. An application may further estimate the revenue opportunity of a keyword for a website as the average revenue generated by users' online sessions for the keyword from the referrer on the website multiplied by the estimated total click count for other websites from search results generated for the keyword by the referrer. An application may then rank the keywords from various referrers for the website by the estimated revenue opportunity for each keyword from a referrer and apply the list of ranked keywords from referrers to optimize monetization of online content. For example, content on the website may be identified for keywords in the ranked list with greatest estimate revenue opportunity and tagged with the keywords for identification by web crawlers for search engines. Additional content may be added to the website for keywords in the ranked list with greatest estimate revenue opportunity. Or online keyword auction applications may change the bid value for keywords in the ranked list with greatest estimate revenue opportunity. For any of these applications, a valuation of a keyword for users' online sessions on a website may be generated using the present invention. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for generating a valuation of revenue opportunity for a keyword from a valuation of online sessions on a website from user activities following a keyword search, in accordance with an aspect of the present invention;

FIG. 3 is a flowchart for generally representing the steps undertaken in one embodiment for optimizing monetization of content by generating a valuation of keywords on a website from users' online sessions following a keyword search, in accordance with an aspect of the present invention;

FIG. 4 is a flowchart for generally representing the steps undertaken in one embodiment for calculating the revenue generated for online sessions of users for pairs of keyword/referrer for a website, in accordance with an aspect of the present invention; and

FIG. 5 is a flowchart for generally representing the steps undertaken in one embodiment for estimating the revenue opportunity of the pairs of keyword/referrer for a website, in accordance with an aspect of the present invention.

### DETAILED DESCRIPTION

### Exemplary Operating Environment

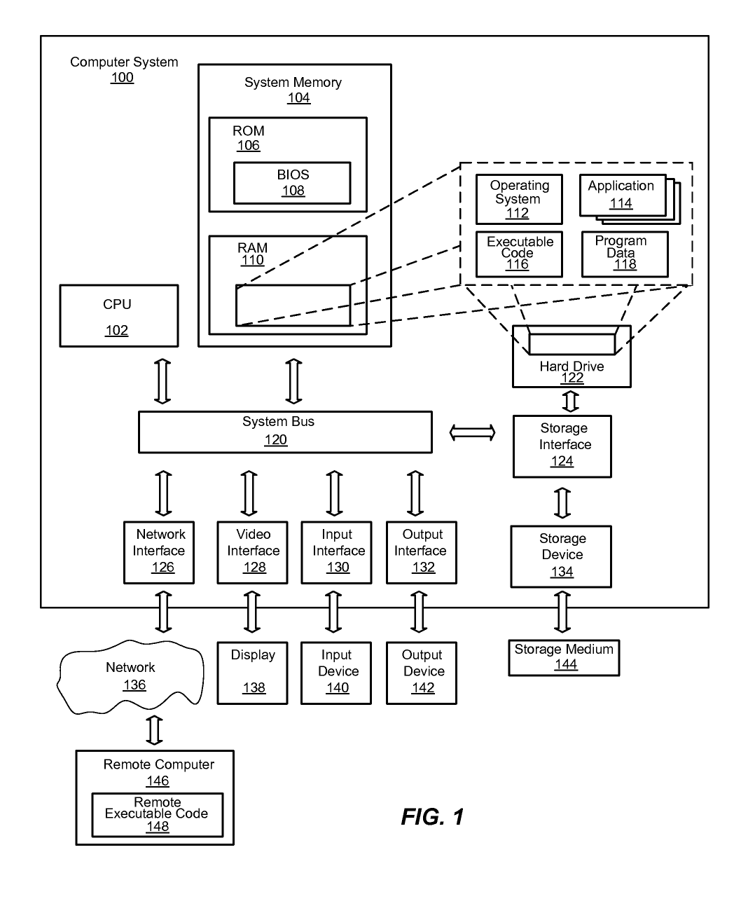

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

Generating a Valuation of Revenue Opportunity for a Keyword from a Valuation of Online Sessions on a Website from User Activities Following a Keyword Search

The present invention is generally directed towards a system and method for generating a valuation of revenue opportunity for a keyword from a valuation of online sessions on a website from user log activities following a keyword search. As used herein, a website means a collection of related web pages, typically interconnected from a home page. In general, users may submit a query with a keyword to a search engine and may subsequently click on a search result link, either a sponsored or algorithmic search result link, and land on a web page of a website. A keyword/referrer may mean a pair of a keyword and a referrer such as a search engine that provided a link that may be selected by a user to land on a web page of a website. The revenue generated for online sessions of users for pairs of keyword/referrer may be calculated from activities performed by each of the users on the website during the online sessions and may be added to a sum representing the session value for the pair of keyword/referrer on the website. In an embodiment, the revenue opportunity of the pairs of keyword/referrer for a website may be estimated by multiplying the session value by the difference of a total count of clicks for multiple websites on search results by a referrer for the keyword and a count of clicks for the website on search results by a referrer for the keyword for a specified period such as a day, month, quarter, and so forth. The pairs of keyword/referrer may be ranked for the website by the estimated revenue opportunity, and then applied in an embodiment to optimize monetization of online content.

As will be seen, the present invention may support many applications for generating a valuation of revenue opportunity for a keyword from a valuation of online sessions on a website following a keyword search. For example, content on the website may be identified for keywords in the ranked list with the greatest estimate revenue opportunity and tagged with the keywords for identification by web crawlers for search engines. Or online keyword auction applications may change the bid value for keywords in the ranked list with greatest estimate revenue opportunity. As will be understood, the various block diagrams, flow charts and scenarios described herein are only examples, and there are many other scenarios to which the present invention will apply.

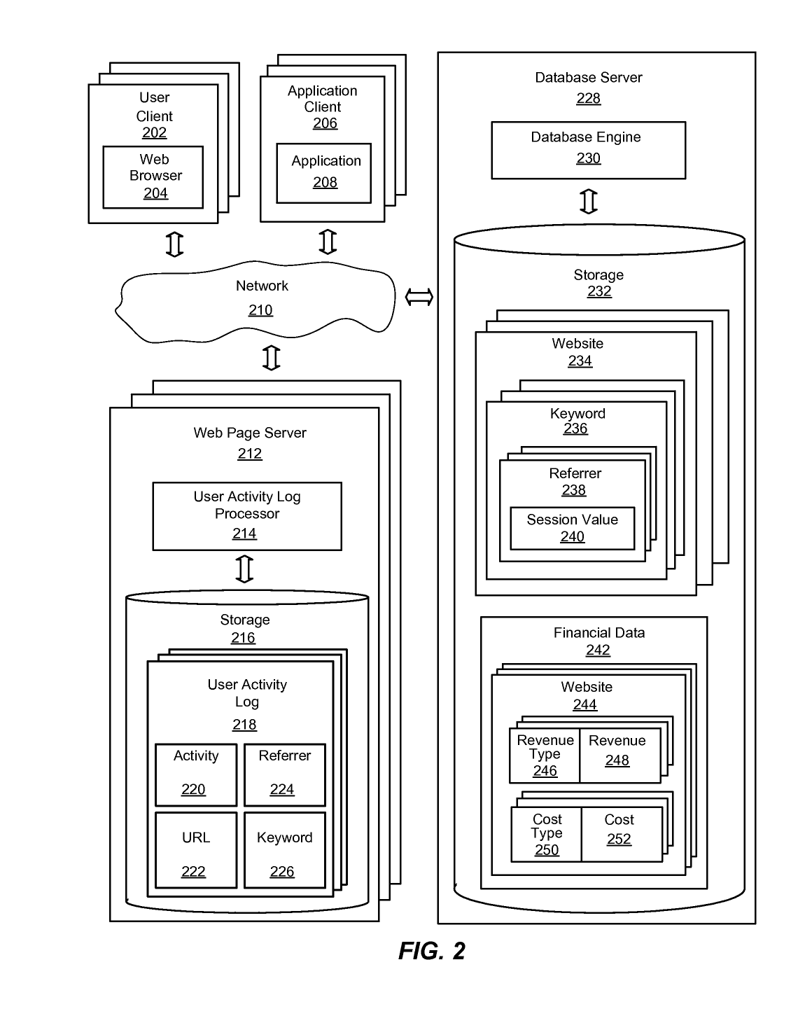

Turning to FIG. 2 of the drawings, there is shown a block diagram generally representing an exemplary architecture of system components for generating a valuation of revenue opportunity for a keyword from a valuation of online sessions on a website from user activities following a keyword search. Those skilled in the art will appreciate that the functionality implemented within the blocks illustrated in the diagram may be implemented as separate components or the functionality of several or all of the blocks may be implemented within a single component. For example, the functionality for the user activity log processor 214 may be included in the same component as the database engine 230. Or the functionality of the user activity log processor 214 may be implemented as a separate component from the database engine 230 as shown. Moreover, those skilled in the art will appreciate that the functionality implemented within the blocks illustrated in the diagram may be executed on a single computer or distributed across a plurality of computers for execution.

In various embodiments, one or more user client computers 202 may be operably coupled to one or more web page servers 212 by a network 210. The user client computer 202 may be a computer such as computer system 100 of FIG. 1. The network 210 may be any type of network such as a local area network (LAN), a wide area network (WAN), or other type of network. A web browser 204 may execute on the user client computer 202 and may include functionality for receiving a request to retrieve a web page and functionality for sending the request to a web page server to retrieve the requested web page. In general, the web browser 204 may be any type of interpreted or executable software code such as a kernel component, an application program, a script, a linked library, an object with methods, and so forth. The web browser may alternatively be a processing device such as an integrated circuit or logic circuitry that executes instructions represented as microcode, firmware, program code or other executable instructions that may be stored on a computer-readable storage medium.

The web page server 212 may be any type of computer system or computing device such as computer system 100 of FIG. 1. In general, the web page server 212 may provide services for processing a request to retrieve a web page and serve the web page to a user client 202. In particular, the web page server 212 may include a user activity log processor 214 for extracting user activities on URLs (Uniform Resource Locator) of web pages in a user activity log. The user activity log processor 214 may also be any type of executable software code such as a kernel component, an application program, a linked library, an object with methods, or other type of executable software code. The user activity log processor 214 may alternatively be a processing device such as an integrated circuit or logic circuitry that executes instructions represented as microcode, firmware, program code or other executable instructions that may be stored on a computer-readable storage medium. The user activity log processor 214 may be operably coupled to storage 216 on the web page server 212 that may store a user activity log 218 with recorded user activities 220 on URLs 222 that include a referrer 224, which may be represented by a referrer's address such as a URL, and a keyword 226 which may be provided as a referrer parameter.

A database server 228 may be operably coupled to one or more web page servers 212 by the network 210. The database server 228 may be any type of computer system or computing device such as computer system 100 of FIG. 1. A database engine 230 may execute on the database server 228 and may include functionality for storing and retrieving data of user activities on properties of a website and financial data for properties of a website. The database engine 230 may be operably coupled to database storage 232 on the database server 228 that may store a session value 240 for one or more referrers 238 for one or more keywords 236 for one or more websites 234. The database storage 232 may also store financial data 242 for websites 244, including revenue 248 for revenue types 246 and cost 252 for cost types 250.

Those skilled in the art will also appreciate that many of the components of the computer system 100 and the system components for generating a valuation of online sessions on a website from user activities following a keyword search illustrated in FIG. 2 may be implemented in various embodiments within a system-on-a-chip architecture including memory, external interfaces, the operating system, the user activity log processor and the database engine. System-on-a-chip implementations are common for special purpose hand-held devices, such as mobile phones, digital music players, personal digital assistants and the like.

The present invention may support many applications for optimizing monetization of content by generating a valuation of a keyword on a website from users' online sessions following a keyword search. For example, an application may calculate the average revenue generated by users' online session for a keyword from a referrer, and the application may then estimate the revenue share attributed to the keyword for the website from an estimated total click count for websites from search results generated for the keyword by the referrer. An application may further estimate the revenue opportunity of a keyword for a website as the average revenue generated by users' online sessions for the keyword from the referrer on the website multiplied by the estimated total click count for other websites from search results generated for the keyword by the referrer. An application may then rank the keywords from various referrers for the website by the estimated revenue opportunity for each keyword from a referrer and apply the list of ranked keywords from referrers to optimize monetization of online content. For example, content on the website may be identified for keywords in the ranked list with greatest estimate revenue opportunity and tagged with the keywords for identification by web crawlers for search engines. Additional content may be added to the website for keywords in the ranked list with greatest estimate revenue opportunity. Online keyword auction applications may increase bid value for keywords in the ranked list with greatest estimate revenue opportunity. For any of these applications, a valuation of a keyword for users' online sessions on a website may be generated using the present invention from user activities following a keyword search.

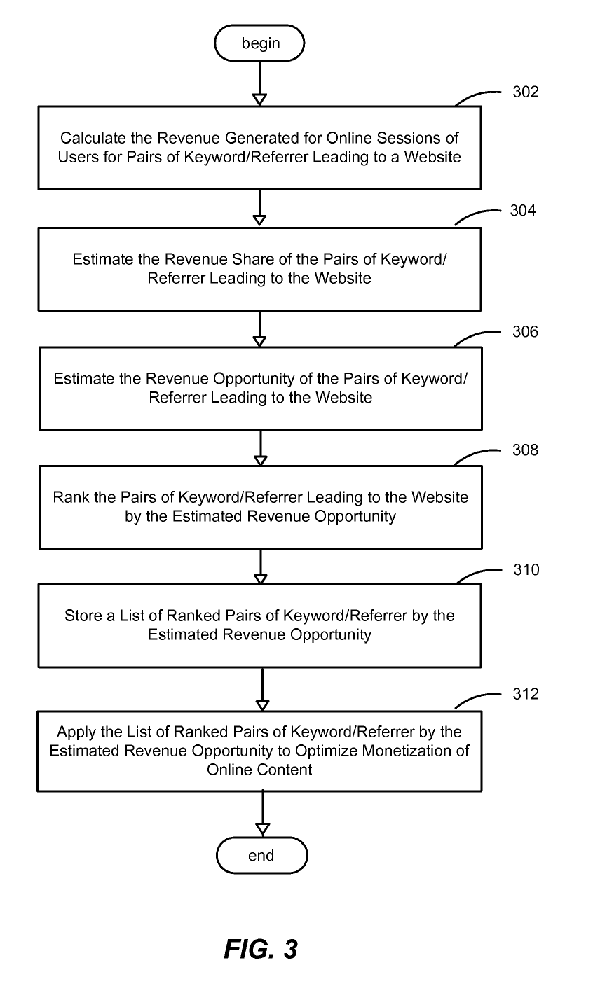

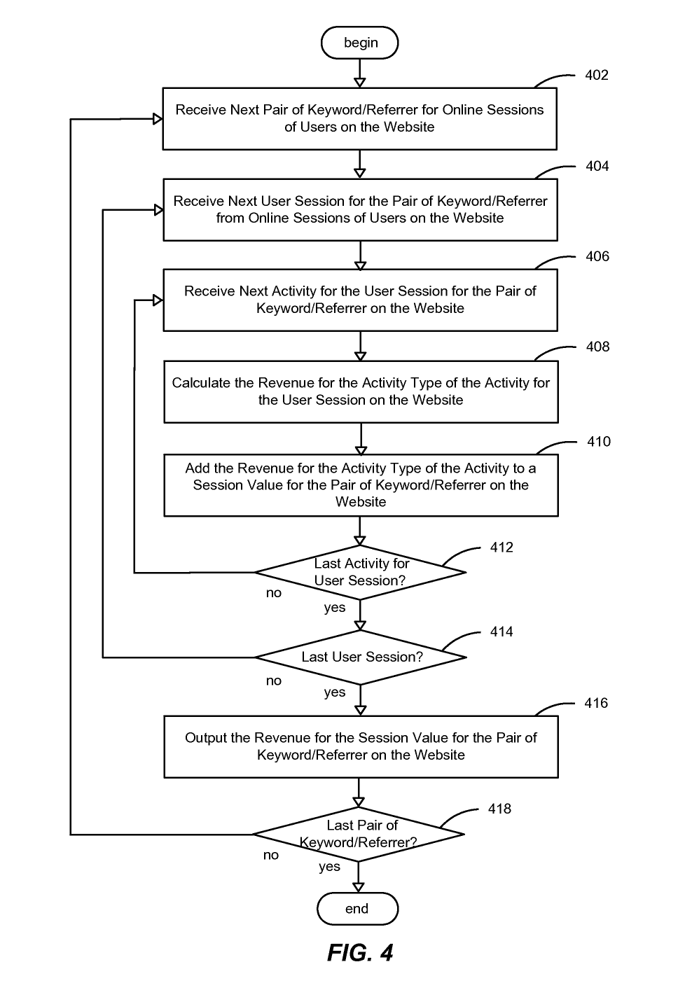

FIG. 3 presents a flowchart for generally representing the steps undertaken in one embodiment for optimizing monetization of content by generating a valuation of keywords on a website from users' online sessions following a keyword search. At step 302, the revenue generated for online sessions of users for pairs of keyword/referrer leading to a website may be calculated. In general, the revenue generated for online sessions of users may be derived from activities performed by each of the users on the website during the online sessions. For instance, examples of activities may include viewing an advertisement on an email property for a particular country, clicking on an advertisement for a real estate property, entering a search query on a photo sharing property and so forth. Calculating the revenue generated for online sessions of users for pairs of keyword/referrer leading to a website may be described in further detail in conjunction with FIG. 4.

At step 304, the revenue share of the pairs of keyword/referrer leading to the website may be estimated in various embodiments. In an embodiment, the revenue share attributed to each keyword leading to the website may be estimated from an estimated total click count for websites from search results generated for the keyword by the referrer. For instance, the total number of search result clicks on a referrer such as a search engine for a keyword may be estimated in practice by a tool provided by the referrer. In an embodiment, the revenue share of a pair of keyword/referrer may be calculated by multiplying the revenue for the online user sessions for the pair of keyword and referrer leading to the website and a percentage of an estimated click count from search results generated for the keyword and referrer leading to the website. The percentage may be calculated as the ratio of the estimated click count for the website and the estimated total click count for websites from the search results generated for the keyword by the referrer.

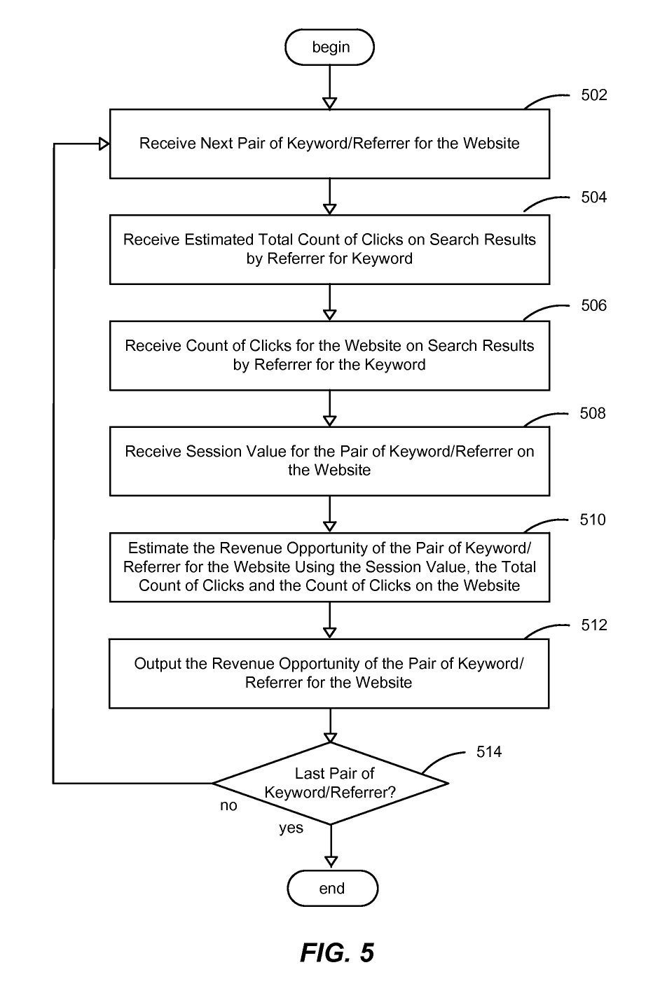

At step 306, the revenue opportunity of the pairs of keyword/referrer leading to the website may be estimated. In an embodiment, the revenue opportunity of a keyword for a website may be estimated as the average revenue generated by users' online sessions for the keyword from the referrer on the website multiplied by the difference of a click count for multiple websites on search results for the keyword and a click count for the website on search results for the keyword. Estimating the revenue opportunity of pairs of keyword/referrer leading to a website may be described in further detail in conjunction with FIG. 5. In various other embodiments, the revenue opportunity of a keyword for a website may be estimated as the difference of the revenue share of the keyword for multiple websites on search results for the keyword and the revenue share of the keyword for the website on search results for the keyword.

At step 308, the pairs of keyword/referrer leading to a website may be ranked by the estimated revenue opportunity. And the list of pairs of keyword/referrer ranked by the estimated revenue opportunity may be stored for the website at step 310. The list of pairs of keyword/referrer ranked by the estimated revenue opportunity for the website may be applied at step 312 to optimize monetization of online content. For example, content on the website may be identified for keywords in the ranked list with the greatest estimate revenue opportunity and tagged with the keywords for identification by web crawlers for search engines. Online keyword auction applications may also increase bid value for keywords in the ranked list with greatest estimate revenue opportunity.

FIG. 4 presents a flowchart for generally representing the steps undertaken in one embodiment for calculating the revenue generated for online sessions of users for pairs of keyword/referrer for a website. At step 402, a pair of keyword/referrer may be received for online sessions of users on the website. A user session may be received for the pair of keyword/referrer at step 404 from online sessions of users on the website. The user session represents the sequence of browsing activities on the website by a user after landing on the website following a keyword search.

At step 406, an activity on the website may be received for the user session for the pair of keyword/referrer, and the revenue for the activity type of the activity on the website for the user session may be calculated at step 408. To calculate the revenue for activities for a user session on a website, in general, values for types of activities of a user session on website may be accumulated and input into a function with values of revenue types associated with activities of the user session on the website. In an embodiment, the activity type of a user on a website may be retrieved from a data cube, which may be referred to as ActivityCube, with a dimension of user identifiers, a dimension of website property identifiers, and a dimension of activity type identifiers. In particular, a query function, AccessActivityCube (User U, Property P, Activity A) may be invoked in an embodiment to return the value on the cell (U, P, A) which may store a value of the activity identified by the activity type. The type of value in each of the cells of the data cube may vary according to the activity type and the value in each of the cells of the data cube depends on the values of each of the three axes. For example, if a user may have four photos on a photo sharing website and may use 1.35 MB of storage space on website servers, then the cell of the data cube corresponding to the dimensions (User ID, PhotoSharing ID, StorageUtilization) may be assigned the value of 1.35 MB, where the website identifier is PhotoSharing ID and the activity is StorageUtilization. As another example, if there have been 38 page views for a user, then the cell of the data cube corresponding to the dimensions (User ID, PhotoSharing ID, PageViews) may be assigned the value of 38, where the website identifier is PhotoSharing ID and the activity is PageViews. And, if a user may have a monthly premium subscription of $3.25, then the cell of the data cube corresponding to the dimensions (User ID, PhotoSharing ID, SubscriptionAmt) may be assigned the value of $3.25, where the website identifier is PhotoSharing ID and the activity is SubscriptionAmt.

The revenue for the activity type may then be calculated for the activity of the user session on the website by accessing a financial data matrix, referred to as FinanceMatrix (Property P, RevenueCostType T), with two dimensions to retrieve a revenue value for a revenue type associated with an activity type for a website. The first dimension is a dimension of website property identifiers, and the second dimension is a dimension of revenue and cost type identifiers. The second dimension may thus have an identifier for a revenue type such as advertising click revenue, advertising impression display revenue, premium subscription revenue, and so forth. And the second dimension may also have an identifier for a cost type such as bandwidth usage costs, storage costs, amortized employee operating costs for websites, and so forth. Once the revenue for the activity type may be calculated for the activity of the user session on the website, the revenue calculated for the activity type of the activity may be added to the session value for the pair of keyword/referrer on the website at step 410.

In various embodiments, the session value may be calculated as the difference of the revenue for activities during the online session and the cost for activities during the online session. Each online property may have several cost factors that may be identified and assigned a cost value. For example, data center costs may have identified cost factors such as bandwidth usage costs for serving web pages to user clients, storage costs for data storage used in various services by individual users of the services, amortized employee costs for websites, and so forth. To calculate the cost for the activity type of an activity for a user session on the website, a financial data matrix, referred to as FinanceMatrix (Property P, RevenueCostType T), with two dimensions may be accessed in an embodiment to retrieve a cost value for a cost type associated with an activity type for a website. The first dimension is a dimension of website property identifiers, and the second dimension is a dimension of revenue and cost type identifiers. The second dimension may thus have an identifier for a cost type such as bandwidth usage costs, storage costs, amortized employee operating costs for websites, and so forth. Once the cost for the activity type may be calculated for the user session on the website, the session value of a user session may be calculated as the difference of the revenue for the user session and the cost for the user session.

In yet other embodiments, the session value may be calculated as a weighted aggregation of revenue by level of the web page and category of content of the web page on which the activity occurred. The level of the web page is the number of the position of the web page in the sequence of web page visits for the user session from the keyword search. For instance, the landing page from the keyword search where the user session initiates is level 1. The second web page visited in the user session is level 2, the third web page visited in the user session is level 3, and so on. As the level increases from 1 to n, attribution of revenue generated for an activity occurring on a web page at each level can be reduced from 100% to x % by a function such as x=LevelFunction(n). For instance, 100% revenue can be attributed at level 1 in an embodiment, but the revenue may reduce by 10% at each level after that. The function that determines how much revenue to attribute based on the level can be defined by business analysts and can vary for each business case.

In addition to the level of the web page, the session value may be calculated as a weighted aggregation of revenue by how closely the category of content of the web page on which the activity occurred matches the category of the keyword for the pair of keyword/referrer. For example, where the keyword searched is “Finance”, the categories of “Tax”, “Income Tax” & “Stocks” for content of web pages in the user session may match the same category as the keyword “Finance”, and 100% of the revenue calculated may be added to the session value. However, for web page content where the category is “Mail” & “Mail PSI” that is not the same category as “Finance”, only a limited percentage or no revenue should be added to the session value.

After the revenue calculated for the activity type of the activity may be added to the session value for the pair of keyword/referrer on the website at step 410, it may be determined at step 412 whether the last activity for the user session was received. If not, then processing may continue at step 406 where the next activity on the website may be received for the user session for the pair of keyword/referrer. Otherwise, if it may be determined that the last activity for the user session was received at step 412, then it may be determined at step 414 whether the last user session was received for the pair of keyword/referrer from online sessions of users on the website. If not, then processing may continue at step 404 where the next user session may be received for the pair of keyword/referrer from online sessions of users on the website. Otherwise, if it may be determined that the last user session was received at step 414, then the revenue for the session value may be output at step 416 for the pair of keyword/referrer from online sessions of users on the website.

At step 418, it may be determined whether the last pair of keyword/referrer may be received for online sessions of users on the website. If not, then processing may continue at step 402 where the next user session may be received for the pair of keyword/referrer from online sessions of users on the website. Otherwise process may be finished for calculating the revenue generated for online sessions of users for pairs of keyword/referrer for a website.

FIG. 5 presents a flowchart for generally representing the steps undertaken in one embodiment for estimating the revenue opportunity of the pairs of keyword/referrer for a website. At step 502, a pair of keyword/referrer may be received for the website. And an estimated total count of clicks for multiple websites on search results by a referrer for the keyword may be received at step 504. In an embodiment, the total number of search result clicks on a referrer such as a search engine for a keyword may be estimated by a tool provided by the referrer. And a count of clicks for the website on search results by a referrer for the keyword may be received at step 506. In an embodiment, a website can keep a count of clicks coming from a referrer for a given keyword by parsing http referrer for parameters main domain name and “q=” (for keyword).

At step 508, a session value for the pair of keyword/referrer on the website may be received. For example, the session value output at step 416 may be received for the pair of keyword/referrer on the website. At step 510, the revenue opportunity of the pairs of keyword/referrer for a website may then be estimated using the session value, the total count of clicks for multiple websites on search results by a referrer for the keyword, and the count of clicks for the website on search results by a referrer for the keyword. In an embodiment, the revenue opportunity of the pairs of keyword/referrer for a website may be estimated by multiplying a session value by the difference of a total count of clicks for multiple websites on search results by a referrer for the keyword and a count of clicks for the website on search results by a referrer for the keyword.

And at step 512, the revenue opportunity of the pairs of keyword/referrer for a website may be output. In an embodiment, the revenue opportunity may be stored in computer-readable storage of an application client or database server. At step 514, it may be determined whether the last pair of keyword/referrer may be received for the website. If not, then processing may continue at step 502 where the next pair of keyword/referrer may be received for the website. Otherwise process may be finished for estimating the revenue opportunity of the pairs of keyword/referrer for a website.

Thus an estimate may be made of the revenue opportunity associated with a keyword based on its session value and the user traffic that the keyword drives to a website from a search query. The session value may provide a key performance indicator as to how a website's revenue share may improve over time and may also identify under monetized keywords for a website that provides insight for optimization of online content. Moreover the cost per click pricing for keywords may be optimized using the session value of a keyword by either offering discounts or by charging premiums based on website's existing revenue share from that keyword.

As can be seen from the foregoing detailed description, the present invention provides an improved system and method for generating a valuation of online sessions from user log activities on a website following a keyword search. The revenue generated for online sessions of users for pairs of keyword/referrer may be calculated from activities performed by each of the users on the website during the online sessions and may be added to a sum representing the session value for the pair of keyword/referrer on the website. In an embodiment, the revenue opportunity of the pairs of keyword/referrer for a website may be estimated by multiplying the session value by the difference of a total count of clicks for multiple websites on search results by a referrer for the keyword and a count of clicks for the website on search results by a referrer for the keyword. The pairs of keyword/referrer may be ranked for the website by the estimated revenue opportunity, and then applied in an embodiment to optimize monetization of online content. As a result, the system and method provide significant advantages and benefits needed in contemporary computing, and more particularly in online systems and applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-implemented method for generating a valuation of online user sessions from a keyword search, comprising:
calculating a revenue for a plurality of online user sessions for each of a plurality of pairs of keyword and referrer on a website;
estimating a revenue opportunity for each of the plurality of pairs of keyword and referrer on the website using the revenue for the plurality of online user sessions for each of the plurality of pairs of keyword and referrer on the website;
ranking the plurality of pairs of keyword and referrer on the website by the revenue opportunity for each of the plurality of pairs of keyword and referrer on the website; and
storing a list of ranked pairs of keyword and referrer on the website in a computer-readable storage medium.

2. The method of claim 1 further comprising identifying content on the website for at least one keyword in the list of ranked pairs of keyword and referrer on the website and tagging the content with the at least one keyword.

3. The method of claim 1 further comprising bidding in an online keyword auction on at least one keyword in the list of ranked pairs of keyword and referrer on the website.

4. The method of claim 1 further comprising estimating a revenue share for each of the plurality of pairs of keyword and referrer on the website by multiplying the revenue for the plurality of online user sessions for each of the plurality of pairs of keyword and referrer on the website and a percentage of an estimated click count from search results generated for each of the plurality of keywords in each of the plurality of pairs of keyword and referrer on the website.

5. The method of claim 1 wherein calculating the revenue for the plurality of online user sessions for each of the plurality of pairs of keyword and referrer on the website comprises receiving a pair of keyword and referrer of the plurality of pairs of keyword and referrer from an online user session of the plurality of online user sessions on the website.

6. The method of claim 1 wherein calculating the revenue for the plurality of online user sessions for each of the plurality of pairs of keyword and referrer on the website comprises receiving an activity for a pair of keyword and referrer of the plurality of pairs of keyword and referrer from an online user session of the plurality of online user sessions on the website.

7. The method of claim 1 wherein calculating the revenue for the plurality of online user sessions for each of the plurality of pairs of keyword and referrer on the website comprises calculating a revenue of an activity type of an activity for a pair of keyword and referrer of the plurality of pairs of keyword and referrer from an online user session of the plurality of online user sessions on the website.

8. The method of claim 1 wherein calculating the revenue for the plurality of online user sessions for each of the plurality of pairs of keyword and referrer on the website comprises calculating a cost of an activity type of an activity for a pair of keyword and referrer of the plurality of pairs of keyword and referrer from an online user session of the plurality of online user sessions on the website.

9. The method of claim 1 wherein calculating the revenue for the plurality of online user sessions for each of the plurality of pairs of keyword and referrer on the website comprises calculating a difference of a plurality of revenues of a plurality of activities for a pair of keyword and referrer of the plurality of pairs of keyword and referrer and a plurality of costs of a plurality of activities for a pair of keyword and referrer of the plurality of pairs of keyword and referrer.

10. The method of claim 1 wherein calculating the revenue for the plurality of online user sessions for each of the plurality of pairs of keyword and referrer on the website comprises adding the revenue for the plurality of online user sessions for each of the plurality of pairs of keyword and referrer on the website to a session value for each of the plurality of pairs of keyword and referrer on the website.

11. The method of claim 1 wherein estimating the revenue opportunity for each of the plurality of pairs of keyword and referrer on the website using the revenue for the plurality of online user sessions for each of the plurality of pairs of keyword and referrer on the website comprises receiving a pair of keyword and referrer of the plurality of pairs of keyword and referrer on the website.

12. The method of claim 1 wherein estimating the revenue opportunity for each of the plurality of pairs of keyword and referrer on the website using the revenue for the plurality of online user sessions for each of the plurality of pairs of keyword and referrer on the website comprises receiving a click count of a plurality of websites on search results for a keyword of the plurality of pairs of keyword and referrer on the website.

13. The method of claim 1 wherein estimating the revenue opportunity for each of the plurality of pairs of keyword and referrer on the website using the revenue for the plurality of online user sessions for each of the plurality of pairs of keyword and referrer on the website comprises receiving a click count of the website on search results for a keyword of the plurality of pairs of keyword and referrer on the website.

14. The method of claim 1 wherein estimating the revenue opportunity for each of the plurality of pairs of keyword and referrer on the website using the revenue for the plurality of online user sessions for each of the plurality of pairs of keyword and referrer on the website comprises receiving a session value for a pair of keyword and referrer of the plurality of pairs of keyword and referrer on the website.

15. The method of claim 1 wherein estimating the revenue opportunity for each of the plurality of pairs of keyword and referrer on the website using the revenue for the plurality of online user sessions for each of the plurality of pairs of keyword and referrer on the website comprises multiplying a session value by the difference of a click count of a plurality of websites on search results for a keyword of the plurality of pairs of keyword and referrer and a click count of the website on search results for a keyword of the plurality of pairs of keyword and referrer.

16. A computer-readable storage medium having computer-executable instructions for performing the method comprising:
calculating a revenue for a plurality of online user sessions for each of a plurality of pairs of keyword and referrer on a website;
estimating a revenue opportunity for each of the plurality of pairs of keyword and referrer on the website by multiplying the revenue for the plurality of online user sessions for each of the plurality of pairs of keyword and referrer by the difference of a click count of a plurality of websites on search results for a keyword of the plurality of pairs of keyword and referrer and a click count of the website on search results for a keyword of the plurality of pairs of keyword and referrer; and
outputting the revenue opportunity for each of the plurality of pairs of keyword and referrer on the website.

17. The method of claim 16 further comprising identifying content on the website for at least one keyword from the plurality of pairs of keyword and referrer on the website and tagging the content with the at least one keyword.

18. A computer system for generating a valuation of online user sessions from a keyword search, comprising:
means for calculating a revenue for a plurality of online user sessions for each of a plurality of pairs of keyword and referrer on a website;
means for estimating a revenue opportunity for each of the plurality of pairs of keyword and referrer on the website using the revenue for the plurality of online user sessions for each of the plurality of pairs of keyword and referrer on the website;
means for ranking the plurality of pairs of keyword and referrer on the website by the revenue opportunity for each of the plurality of pairs of keyword and referrer on the website; and
means for storing a list of ranked pairs of keyword and referrer on the website in a computer-readable storage medium.

19. The computer system of claim 18 further comprising means for estimating a revenue share for each of the plurality of pairs of keyword and referrer on the website.

20. The computer system of claim 18 further comprising means for optimizing content of the website using the list of ranked pairs of keyword and referrer.
